(19) United States
(12) Patent Application Publication
(10) Pub. No.: US 2024/0150080 A1
(43) Pub. Date: May 9, 2024

(54) DRY POWDER COATING FOR ENHANCED PRINTING ON STAINLESS STEEL AND METHOD THEREOF

(71) Applicants: TERVIS TUMBLER COMPANY, NORTH VENICE, FL (US); TMF Plastic Solutions, Bradenton, FL (US)

(72) Inventors: Curt Mahlstedt, North Venice, FL (US); Dhamodharan Vayalur, North Venice, FL (US); Justin Guthrie, Bradenton, FL (US); Corey Ryan, Bradenton, FL (US); Greg Kuppler, Bradenton, FL (US); Eric Lai, Hong Kong (HK)

(21) Appl. No.: 18/501,125

(22) Filed: Nov. 3, 2023

Related U.S. Application Data
(60) Provisional application No. 63/382,214, filed on Nov. 3, 2022.

(51) Int. Cl. B65D 25/34; A47G 19/22; A47J 41/02

(52) U.S. Cl. CPC B65D 25/34; A47G 19/2272; A47G 19/2288; A47J 41/028

(57) ABSTRACT

A method of coating and decorating a steel surface is described herein. The method includes applying a powder-coat, curing the powder-coat, printing a design, decoration, or logo in ink, and curing the ink resulting in an improved decorated steels surface. Additionally, a decorated steel surface is described, having a first layer of steel, a second layer of powder-coating, and a third layer of ink. A decorated stainless steel container is also described having an interior surface and an exterior surface of steel. The exterior surface having a first layer of powder-coating and a second layer of ink.

### CROSS-REFERENCE TO RELATED APPLICATIONS

This application claims priority to U.S. Provisional Application No. 63/382,214 filed Nov. 3, 2022, which is hereby incorporated by reference in its entirety.

### FIELD

This disclosure relates broadly to printing on stainless steel surfaces, and more specifically to printing on stainless steel containers such as drinkware.

### BACKGROUND OF THE INVENTION

Printing on steel, or stainless steel, is a method practiced for many years. One such method is to print ink onto a primed stainless steel surface. These printed stainless steel surfaces, over time, will frequently chip or peel. This happens because the ink will separate from the stainless steel surface often due to wear and tear, excess heat, and/or harsh washing conditions. Therefore, there exists a need for an improved printing process to improve the longevity of ink adhesion on stainless steel surfaces.

### BRIEF SUMMARY

Embodiments of the present invention address the above needs and/or achieve other advantages by providing a method of decorating a stainless steel surface, a decorated stainless steel surface, and a decorated stainless steel container.

In one aspect, a method of decorating a stainless steel surface is disclosed. The method of decorating a stainless steel surface includes: providing a steel surface, applying a powder-coat powder onto the steel surface, curing the powder-coat powder on the steel surface to obtain a powder-coated steel surface, printing a UV-curable ink onto the powder-coated steel surface, wherein the surface is rotating at a speed of 2.5 rotations per second (RPS) at a distance of 1 mm between the print-head and the surface, and curing the UV-curable ink on the powder-coated steel surface at 60% to 80% UV exposure at a distance between the printed surface and the light source of ¼ inch to 1/16 inch. In some embodiments, the method may further include washing the stainless steel surface prior to applying the powder-coat powder onto the steel surface. In some embodiments, the method further includes charging the surface prior to applying the powder-coat powder.

In some embodiments, the powder-coat powder is a polyester resin. In some embodiments, curing the powder-coat powder comprises heating the powder-coat powder on the steel surface at a temperature of about 150° C. to 200° C.

In another aspect, a decorated steel surface formed by the method described herein is disclosed. The decorated stainless steel surface including a first layer of steel, a second layer of powder-coating, and a third layer of ink.

In another aspect, a decorated stainless steel container is disclosed. The container comprising an interior surface and a decorated exterior surface formed by the method described herein. The exterior surface comprised of stainless steel, a layer of powder-coating, and a layer of ink.

In some embodiments, the decorated stainless steel container further comprises a lid. Additionally, or alternatively, the decorated stainless steel container comprises a sealed vacuum cavity between the interior surface and the exterior surface. In some embodiments, the decorated stainless steel container is configured to contain food and/or beverage. Additionally, or alternatively, the decorated stainless steel container is a tumbler or a bottle.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

The drawings described herein are for illustrative purposes for selected embodiments and not all possible implementations, and are not intended to limit the scope of the present disclosure.

FIG. 1 is a process flow diagram for decorating a stainless steel surface, in accordance with at least one embodiment.

FIG. 2 is a sectional view of a stainless steel surface in accordance with at least one embodiment.

FIG. 3 is a perspective view of a stainless steel surface in accordance with at least one embodiment.

FIG. 4 is a perspective view of a stainless steel container in accordance with at least one embodiment.

### DETAILED DESCRIPTION OF EMBODIMENTS OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

It must be noted that, as used in the specification and the appended claims, the singular forms “a,” “an” and “the” include plural referents unless the context clearly dictates otherwise. The term ‘or” as used herein, with respect to a list of two or more items, elements, components, or materials, is not indicative of a complete disjunction such that the listed items, elements, components, or materials are mutually exclusive of each other. For example, “X, Y, or Z” does not mean that each of X, Y, Z are mutually exclusive of each other. Two or more of X, Y, Z could partially or completely overlap each other or that at least one of X, Y, or Z could be included in or be a subgenus of at least one of another of X, Y, or Z.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

Current methods of decorating stainless steel surfaces include printing ink onto a primed stainless steel surface. However, these decorated surfaces suffer from chipping and peeling as a result of: (1) wear and tear: usage such as the in and out of car cup holders or dropping resulting in dents and ink fracture; (2) over heating: either by too much sun (left in a hot car) or dishwashing (extreme heat would weaken ink bond); and (3) dishwasher: the combination of hot water and detergents are a harsh environment resulting in a fast heat and cool cycle further weakening the bond.

Without wishing to be bound by theory, it is believed that the failures are primarily ink adhesion failure where either fracturing the surface by wear and tear in usage (scratches, gouging) or the application of heat, makes the ink separate from the stainless surface. The ink itself is strong, but the ability to bond with stainless is difficult. It is suspected that the two materials expand at two different rates, during heat cycling over time, creating movement of two materials at different rates. Eventually the ink will separate from the surface. Additionally, though these decorated stainless steel surfaces are not labeled as dishwasher-safe, it is common practice to wash them in a dishwasher and this process aggravates the chipping and peeling problem.

The advantage of the method described herein is the combination of the bond of the powder-coat to stainless and the bond of ink to the powder-coat creating a layered decoration system. Powder-coat has superior durability in adhesion to steel by the nature of its process that bonds it to the steel surface. In the disclosed application method, the clear powder-coat is effectively a strong primer surface for ink. The UV ink applied to the powder-coat surface bonds extremely well. Consequently, the ink and the powder-coat bond move well together, almost as one, on the stainless surface when expansion or contraction is created in the use environment. This layered build up greatly eliminates chipping or peeling to the point that these surfaces are dishwasher safe. We have found in order to achieve desired adhesion and longevity, the thermal properties of the powder coat material and the ink should be similar enough to enable both the powder coat layer and the ink layer to expand and contract at the same rates in the dishwasher and in hot environments. This prevents any cracks, chipping, or peeling of the ink from the powder coat layer.

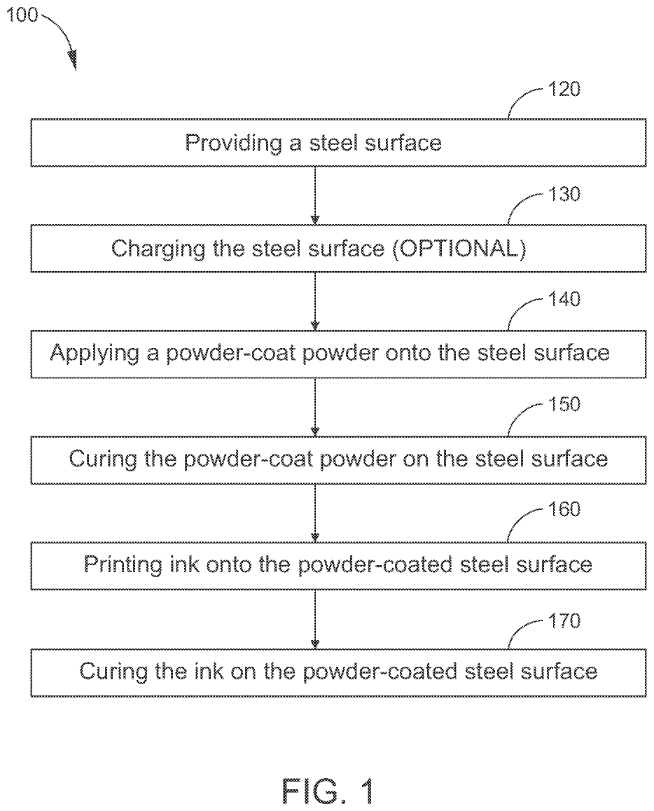

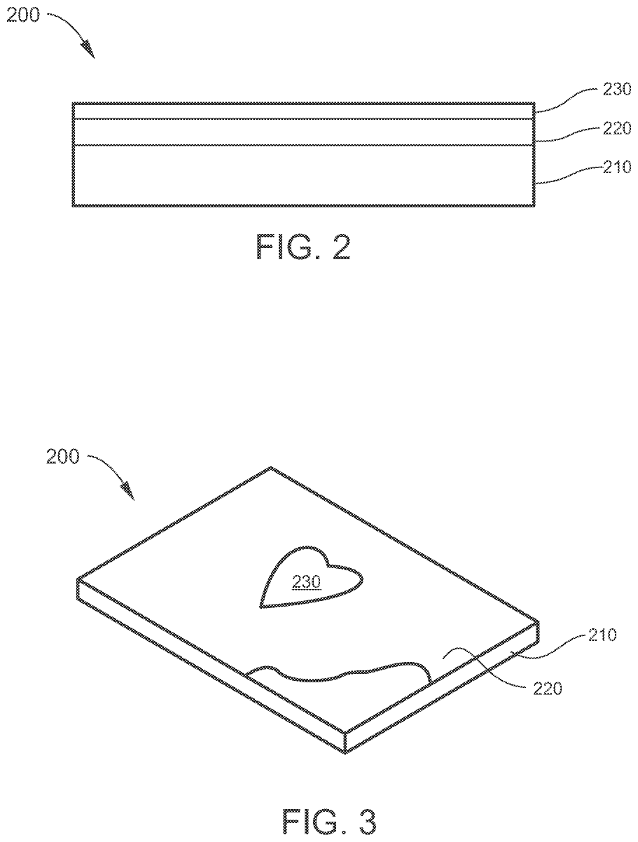

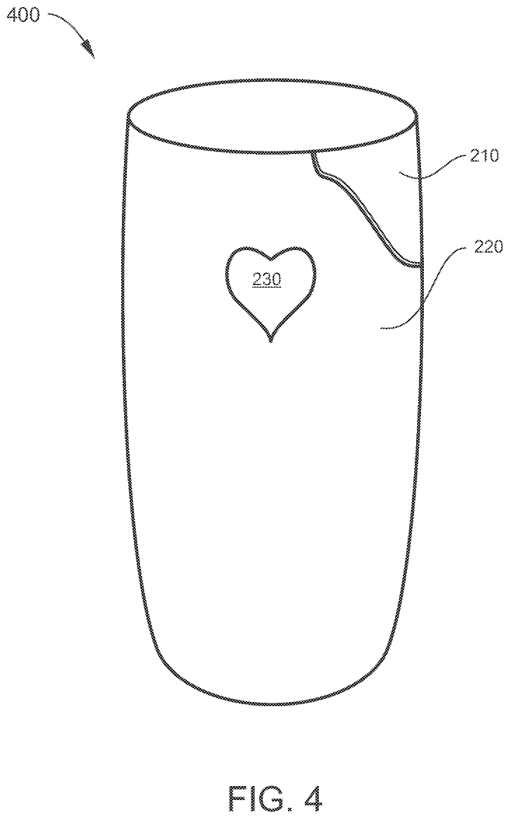

Referring to FIG. 1, the method of decorating a stainless steel surface includes providing a steel surface 120. After providing the steel surface, it may be desirable to clean or wash the steel surface at this time prior to the next step of applying a powder-coat powder onto the steel surface 140. The powder-coat powder may be applied by dipping the stainless steel into the powder-coat powder or spraying the stainless steel with the powder-coat powder. Another method of applying the powder-coat powder is via an electrostatic application which involves electrostatically charging the steel surface 130 to attract the sprayed power-coat powder to stick to the charged surface. Charging the steel surface may include placing the stainless steel container upside down on a metal puck that transfers the negative charge to the cup. It is understood that other methods of applying the powder coat can be used as desired. After applying the powder-coat powder, the method continues with curing the powder-coat powder on the steel surface 150. This may include heating or baking the coated steel surface at a temperature of about 150° C. to about 200° C. Alternatively, curing the powder may comprise using ultraviolet light, for example, 390 nm. Other curing methods may be used without departing from the scope of the invention. The powder-coating may cover the entire external surface of the steel, or cover only portions of the external surface of the steel.

Following curing of the powder-coat, the method continues with printing ink onto the powder-coated steel surface 160 and curing the ink on the powder-coated steel surface 170. The ink may be cured with ultraviolet light, for example 390 nm. The ultraviolet light may be applied using high wattage ultraviolet lamps, for example 8 watts. It is understood that other curing methods can be used. The ink may be printed onto the surface using an inkjet printer, or more specifically a cylindrical inkjet printer. The ink may also be printed using pad printing. The ink is used to print a desired design, decoration, logo, name, or any desired mark or indicia onto the steel item. In the embodiment disclosed, the ink used for printing is a UV-curable ink, although other inks can be used. In some embodiments, the UV-curable ink comprises acrylate and acrylate derivatives. In some embodiments, an additional powder-coat may be applied and cured following the application and curing of the ink. Favorable results have been obtained by printing onto the powder-coat at a speed of 2.3 rotations per second to 2.7 rotations per second, more preferably 2.5 rotations per second. Typically, printing occurs at 3.5 rotations per second to 5 rotations per second; however, we have found that this is too fast to allow each layer of the ink to cure. Additionally, favorable results have been obtained by printing onto the powder-coat at a distance of 0.8 mm to 1.2 mm, preferably 1 mm, between the surface being printed and the print-head. Curing the UV-curable ink occurs at a distance of ¼ inch to 1/16 inch from the UV-light source and the surface of the container and at 60% to 80% ultraviolet light exposure achieves maximum UV-light exposure. The UV-curable ink is cured at 390 nm, based on the specification of the UV-curable ink.

The powder-coat powder may comprise a polyester resin. Additionally, or alternatively, the powder-coat powder may comprise a polycarbonate resin. The powder-coat powder may be a resin comprising: dimethyl benzene-1,3-dicarboxylate, 2,3-dimethylterephthalic acid, and ethane-1,2-diol (CAS NO.25135-73-3), and other resins. The powder-coat powder may further comprise subcomponents, for example: dicumyl peroxide, benzoyl peroxide, and other powders.

The powder-coat powder may also further comprise pigment to coat the steel surface with powder-coat of a desired color. The powder-coat powder may also be free of pigments to coat the steel surface with a colorless, or clear, powder-coat.

The method described above is used to coat and print on steel surfaces to create a long-lasting bond between the steel surface and the design or decoration. The decorated stainless steel surface 300 will comprise a first layer of steel 210, a second layer comprising a powder-coating 220, and a third layer comprising ink 230 in a decoration, design, logo, etc. The decorated stainless surface may also have a fourth layer of an additional powder-coating over the ink decoration.

The method described above may also be used to coat and print on steel containers, such as food and beverage containers, a tumbler for example. The container 400 comprising an interior surface and an exterior surface 210. The exterior surface is steel, with a first layer of powder-coating coating 220 the entire exterior and a second layer of ink 230 in a decoration, design, logo, etc. The decorated steel container may also have a third layer of powder-coating over the ink decoration, design, logo, etc. The decorated steel container may further comprise a lid to keep the contents of the container secure. The decorated steel container may also comprise a sealed vacuum cavity between the interior surface and the exterior surface. The sealed vacuum cavity creates a container capable of maintaining the contents of the container at a desired temperature.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of decorating a stainless steel surface, the method comprising:
providing a steel surface;
applying a powder-coat powder onto the steel surface;
curing the powder-coat powder on the steel surface to obtain a powder-coated steel surface;
printing UV-curable ink onto the powder-coated steel surface, wherein printing occurs at 2.3 rotations per second (RPS) to 2.7 rotations per second (RPS), and wherein printing occurs at a distance of 0.8 mm to 1.1 mm; and
curing the UV-curable ink on the powder-coated steel surface at 60% to 80% ultraviolet exposure at a distance between ¼ inch to 1/16 inch.

2. The method of decorating a stainless steel surface according to claim 1, further comprising charging the steel surface prior to applying the powder-coat powder onto the steel surface.

3. The method of decorating a stainless steel surface according to claim 1, further comprising, after printing ink onto the powder-coated steel surface:
applying a second powder-coat powder; and
curing the second powder-coat powder.

4. The method of decorating a stainless steel surface according to claim 1, wherein the powder-coat powder is a polyester resin.

5. The method of decorating a stainless steel surface according to claim 1, wherein curing the powder-coat powder comprises heating the powder-coat powder on the steel surface at a temperature of about 150° C. to about 200° C.

6. The method of decorating a stainless steel surface according to claim 1, wherein the ultraviolet light is 390 nanometers.

7. The method of decorating a stainless steel surface according to claim 1, further comprising washing the stainless steel surface prior to applying the powder-coat powder onto the steel surface.

8. A decorated stainless steel surface comprising:
a first layer comprising steel;
a second layer comprising a powder-coating; and
a third layer comprising ink,
wherein the decorated stainless steel surface is formed by the method of claim 1.

9. The decorated stainless steel surface according to claim 8, wherein the powder-coating comprises a polyester resin.

10. The decorated stainless steel surface according to claim 8, further comprising a fourth layer comprising a second powder-coating.

11. A decorated stainless steel container comprising:
a container comprising:
an interior surface; and
a decorated exterior surface comprising stainless steel, the exterior surface comprising:
a first layer of powder-coating, and
a second layer of ink,
wherein the decorated exterior surface is formed by the method of claim 1.

12. The decorated stainless steel container according to claim 11, wherein the exterior surface further comprises a third layer of powder-coating.

13. The decorated stainless steel container according to claim 11, wherein the powder-coating comprises a polyester resin.

14. The decorated stainless steel container according to claim 11, further comprising a lid.

15. The decorated stainless steel container according to claim 11, further comprising a sealed vacuum cavity between the interior surface and the exterior surface.

16. The decorated stainless steel container according to claim 11, wherein the container is configured to contain food and/or beverage.

17. The decorated stainless steel container according to claim 11, wherein the container is a tumbler.
